(19) United States
(12) Patent Application Publication
(10) Pub. No.: US 2009/0249640 A1
(43) Pub. Date: Oct. 8, 2009

(54) Device and Method for Removing Wetness

(75) Inventor: Zbigniew SUFLETA, San Jose, CA (US)

Correspondence Address: Vista IP Law Group, LLP, 1885 Lundy Ave., Suite 108, San Jose, CA, 95131, US

(73) Assignee: Zbigniew SUFLETA, San Jose, CA (US)

(21) Appl. No.: 12/418,432

(22) Filed: Apr. 3, 2009

Related U.S. Application Data
(60) Provisional application No. 61/043,013, filed on Apr. 7, 2008.

(51) Int. Cl. F26B 5/14; A47L 13/24

(52) U.S. Cl. 34/397; 15/147.1; 15/104.92

(57) ABSTRACT

A device for removing wetness includes a frame having a slot, a sheet of fluid absorbing material, at least a portion of which is located in the slot, wherein the sheet has a first end and a second end, a first handle coupled to the frame, and a second handle coupled to the first end. A method for removing wetness on a surface includes placing a sheet of fluid absorbing material on a wet surface, and pulling a first end of the sheet relative to a slot in a first direction so that part of the sheet moves through the slot to remove moisture from the sheet.

### RELATED APPLICATION DATA

This application claims the benefit of, and priority to, U.S. Provisional Patent Application No. 61/043,013, filed on Apr. 7, 2008, the entire disclosure of which is expressly incorporated by reference herein.

### FIELD

The present application relates generally to devices and methods for operating on surfaces that are subject to undesired wetness, and more specifically, to devices and methods for removing wetness from courts, such as tennis courts.

### BACKGROUND

Sometimes, it may be desirable to remove moisture, such as moisture resulted from rain, from a court (e.g., a tennis court). Existing devices for removing fluid from courts are inconvenient to use, and may not be efficient in removing fluid accumulated in a pond/pothole. Also, existing devices do not allow wringing to be performed easily. As used in this application, the term “wringing” refers to the act of compressing fluid absorbing material so that some portion of the fluid in the material is released.

### SUMMARY

In accordance with some embodiments, a device for removing wetness includes a frame having a slot, a sheet of fluid absorbing material, at least a portion of which is located in the slot, wherein the sheet has a first end and a second end, a first handle coupled to the frame, and a second handle coupled to the first end.

In accordance with other embodiments, a method for removing wetness on a surface includes placing a sheet of fluid absorbing material on a wet surface, and pulling a first end of the sheet relative to a slot in a first direction so that part of the sheet moves through the slot to remove moisture from the sheet.

Other and further aspects and features will be evident from reading the following detailed description of the embodiments, which are intended to illustrate, not limit, the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a device for removing wetness in accordance with some embodiments;

FIG. 2 illustrates the device of FIG. 1 during a wiping sweep;

FIG. 3 illustrates the device of FIG. 1 during a wringing activity;

FIG. 4a illustrates the device of FIG. 1 during a wiping sweep;

FIG. 4b illustrates a side view of a variation of the device of FIG. 1, showing the device having a single flexible fluid-pushing edge;

FIG. 4c illustrates a side view of another variation of the device of FIG. 1, showing the device having two flexible fluid pushing edges attached at an angle to a lower bar;

FIG. 5 illustrates a variation of the device of FIG. 1, showing the device having wheels attached to a frame that holds a sheet of fluid-absorbing material;

FIG. 6 illustrates a variation of the device of FIG. 1, showing the device having a gutter and a hose attached to the extended lower bar;

FIG. 7 illustrates another device for removing wetness that includes rotating drums next to a wringing slot in accordance with other embodiments;

FIG. 8 illustrates a variation of the device of FIG. 7, wherein one of the drums is propelled by a cranking mechanism;

FIG. 9 illustrates a device for removing wetness in accordance with other embodiments; and

FIG. 10 illustrates the device of FIG. 9, showing the device in a collapsed and disassembled configuration.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

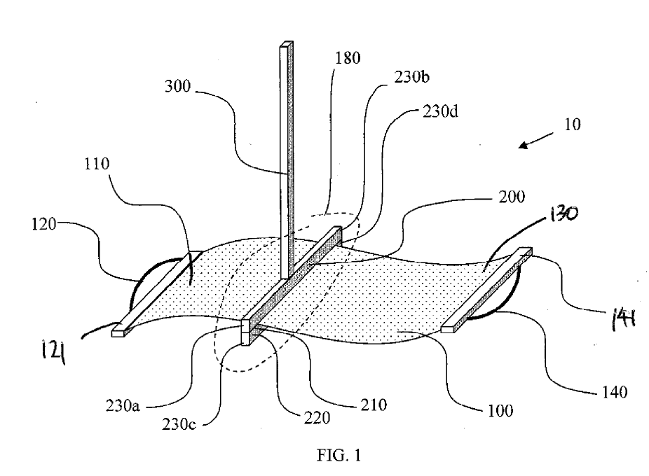

FIG. 1 illustrates a device (10) for removing moisture in accordance with some embodiments. The device (10) includes a sheet of fluid absorbing material (100), a frame (180), and a handle (300).

The sheet of fluid absorbing material (100) has a first end (110), a first handle (120) attached to the first end (110), a second end (130), and a second handle (140) attached to the second end (130). The sheet (100) can be made from any material that is capable of absorbing fluid, such as cloth, foam, or sponge. In some embodiments, the sheet (100) may be implemented using a towel.

The frame (180) is made of two bars (200) and (220). Bar (200) includes ends (230a) (230b), and bar (220) includes ends (230c), (230d). The frame (180) is made by attaching end (230a) of bar (200) to end (230c) of bar (220), and by attaching end (230b) of bar (200) to end (230d) of bar (220), thereby providing a gap (210) between the two bars (200), (220). As shown in the figure, the handles (120), (140) are attached to corresponding support members (121), (141), (e.g., a bar/rod), which allow the respective handles (120), (140) to be secured to the sheet (100). In some cases, the handle (120)/(140) may be secured to the support member (121)/(141) by being integrally formed with the support member (121)/(141). The support member has a size that is slightly larger than the slot (210). For example, the support member may be longer and/or thicker than the slot (210). Such feature prevents the sheet (100) from completely decoupling from the frame (180) during use. The bars (200) (220) can be made from any materials, such as plastic, timber, metal (e.g., aluminum), or fiber glass. The two bars (200) (220) may be attached at the ends (230) using an adhesive, nail(s), and/or screw(s). In other embodiments, the two bars (200) (220) may be attached to each other at the ends (230) using mechanical couplers that are known in the art. In some cases, the mechanical coupler may allow at least one of the ends of the bar (200) to be decoupled from the corresponding end of the bar (220). Such feature may allow the sheet (100) to be replaced if it is worn out.

In further embodiments, the two bars (200) (220) may be integrally formed together such that they are attached to each other after they are formed. In such cases, the frame (180) may be made from an elastic material having an elasticity that allows the frame (180) to be deformed slightly so that the slot (210) can be elastically enlarged for allowing the end (110)/(130) of the sheet (100) with the support member (121)/(141) to be pulled therethrough. Such feature may allow the sheet (100) to be replaced if it is worn out.

In further embodiments, the components for attaching the two ends (230) of each of the bars (200) (220) are operable so that the thickness of the gap (210) can be adjusted, which in turn, varies the amount of force compressing against the sheet of material (100) that is between the two bars (200), (220). The slot length measured along the two bars, is at least as long as the width of the fluid absorbing sheet (100). The slot height, i.e. the height of gap (210) between the two parallel bars (200), (220) of the frame (180), is large enough to allow forced movement of the wet fluid absorbing sheet through the slot, and small enough to squeeze the fluid absorbing material when it moves through the slot (210) so that a portion of the fluid accumulated in the fluid absorbing material (100) gets ejected from it by the squeezing effect. In other embodiments, the slot height may be any dimensions. For example, in other embodiments, the slot height may be longer than a thickness of the sheet (100).

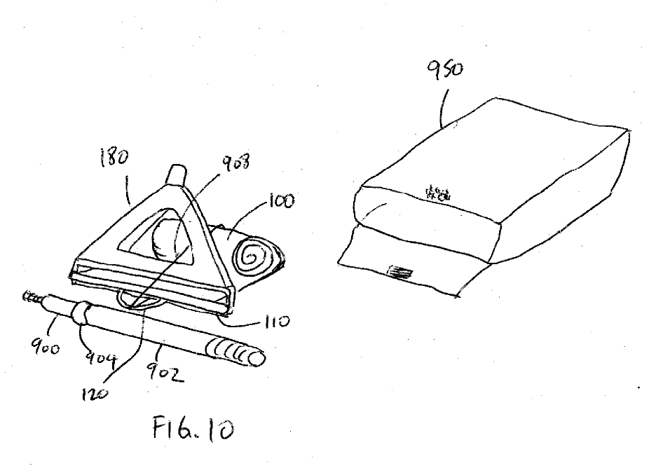

As shown in the figure, the handle (300) is attached to the frame (180). In the illustrated embodiments, the handle (300) is permanently secured to the frame (180). In other embodiments, the handle (300) may be detachably, coupled to the upper bar (200) of the frame (180) (FIGS. 9, 10). For example, the handle (300) may include threads, and may be attached to the frame (180) by screwing the handle (300) to a component on the frame (180) that also includes threads. In other embodiments, other devices known in the art may be provided to allow the handle (300) to be detachably coupled to the framed (180). Also, in some embodiments, the length of the handle (300) may be adjustable. Such may be accomplished, for example, by forming the handle (300) using two elongated members (900), (902) that are positioned concentrically relatively to each other, wherein the two elongated members can slide relative to each other (FIGS. 9, 10). During use, the two elongated members (900), (902) may be moved in opposite directions that are away from each other to lengthen the handle (300). Alternatively, the two elongated members may be moved in opposite directions that are towards each other to shorten the handle (300). In some cases, a securing mechanism (904) may be provided that allows the elongated members to be secured to each other after a desired length of the handle (300) has been accomplished. The securing mechanism may be a screw or a knob that prevents the elongated members (900), (902) from sliding relative to the each other.

The clearance (thickness) of gap/slot (210) and the thickness of fluid absorbing sheet (100) is chosen such that the sheet can be dragged through the gap by pulling either handle (120) or handle (140) and that the sheet is squeezed when being dragged through the gap. In some embodiments, the thickness of the gap (210) is a value between 2 mm and 15 mm, and more specifically, between 4 mm and 6 mm. In other embodiments, the thickness of the gap (210) can have other values. Also, in some embodiments, the thickness of the sheet (100) (when dry and not squeezed) is a value between 3 mm and 20 mm, and more specifically, between 6 mm and 10 mm. In other embodiments, the thickness of the sheet (100) can have other values. In some cases, the thickness of the gap (210) may be larger than the thickness of the fluid absorbing sheet (100). In such cases, the compression of the fluid absorbing sheet (100) to release fluid in the sheet (100) may be accomplished by pulling the sheet (100) at an angle relative to the frame (180) such that the sheet (100) is pressed against one of the bars (200), (220) of the frame (180) as part of the sheet (100) is being pulled through the gap (210).

Various techniques may be used to remove wetness on a surface using the device (10). In some embodiments, use of the device (10) involves two actions applied interchangeably during a surface wiping activity: (1) Sweeping, and (2) Wringing.

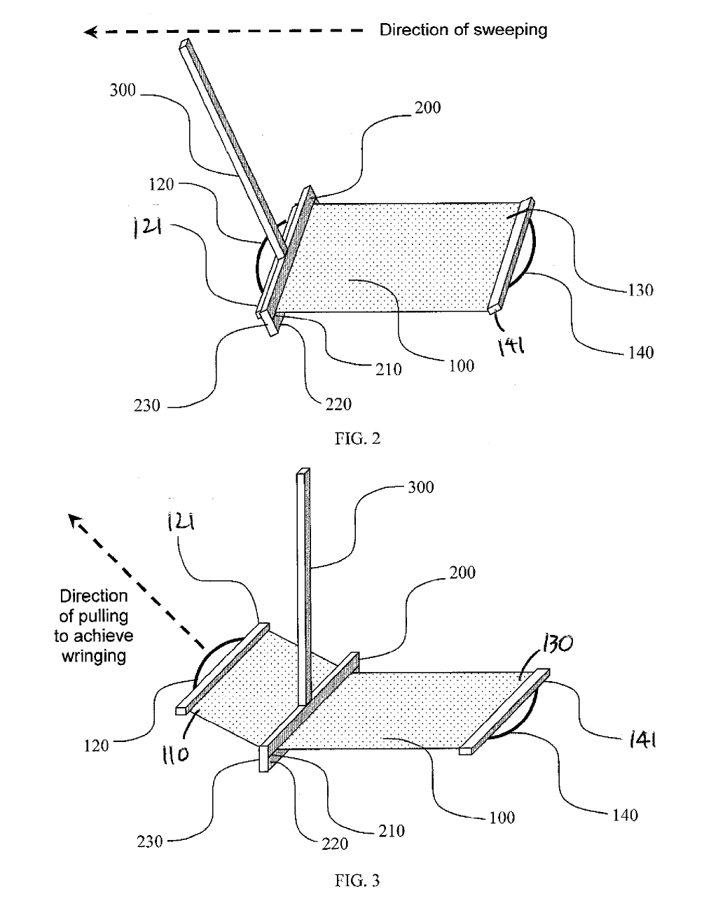

The sweeping activity is illustrated schematically in FIG. 2. Before making a wiping sweep over a wet surface, the fluid absorbing sheet (100) is moved all the way through the frame slot (210) so that the bulk of the sheet (100) resides on one side of the frame (180). Handle (300) positioned at an angle to the wet surface is used to pull the frame (180), which holds the fluid absorbing sheet (100). Sheet (100) resides on one side of the frame (180), i.e., the side opposite to the direction of sweeping, and is held on this side by one of the support members (121) or (141), respectively. As the frame (180) is being pulled in the illustrated direction, the support member (121) prevents the sheet (100) from being separated from the frame (180). This activity is performed until either the fluid absorbing material reaches its absorbing capacity or the device (10) reaches a location that is appropriate for releasing the absorbed fluid. Dragging the sheet (100) of fluid absorbing material over a wet surface tends to be very efficient in removing wetness, especially after the bulk of the fluid was already removed from the surface and what is left resides in potholes or ponds that are hard to reach by known devices that typically do not have enough structural flexibility to adjust to the imperfections of the surface and penetrate potholes or ponds. The illustrated embodiments make it easy for a human operator (or a machine) to drag the fluid absorbing sheet (100) over the surface being wiped.

The wringing activity is illustrated schematically in FIG. 3. The end of fluid absorbing sheet (100) that was close to the bars (200) and (220) during the sweeping activity is pulled up by using the handle attached to this end, i.e. handle (120) or (140), respectively. A portion of the fluid accumulated in the fluid absorbing sheet (100) gets released from the sheet on the side of the bars (200) and (220) that is opposite to the location of the pulling handle. This wringing activity may be applied several times by dragging the fluid absorbing sheet (100) between the bars (200), (220) in opposite directions. The illustrated embodiment is advantageous in that it allows fluid to be removed easily from the fluid absorbing material in the sheet (100). In some embodiments, the pressure applied against the sheet (100) by the bar (200) and/or bar (220) may be adjusted (e.g., by adjusting the screw(s) or mechanical component(s) used to connect the bars (200), (220)), such that the pressure is not too high so as to allow the sheet (100) to be pulled back and forth between the bars (200), (220) without requiring the user to exert too much force, while allowing the bars (200), (220) to squeeze fluid out of the sheet (100) as the sheet (100) is being pulled through the gap (210). In some cases, the squeezing of the sheet (100) to remove moisture therein may be accomplished by pulling the sheet (100) at an angle relative to the frame (180) (such as that shown in the figure), thereby pressing the sheet (100) towards the bar (200) to squeeze out fluid therein.

It should be noted that the device (10) does not need to have the orientation shown during the wringing activity. For example, in other embodiments, a user may be holding the handle (300) with the frame (180) on top (which is opposite to the orientation of the device (10) shown in the figure) while pulling the sheet (100) relative to the frame (180) at an angle (e.g., the plane of the sheet (100) may be about 45° from the handle (300) while the sheet (100) is being pulled).

At the end of the wringing activity the fluid absorbing sheet (100) resides on one of the sides of the bars (200), (220) and therefore is ready for supporting the next sweeping activity. For example, if additional sweeping activity is desired, the device of FIG. 1 can be used to sweep in the opposite direction—i.e., opposite to that shown in FIG. 2. Then the sheet (100) can be pulled across the gap (210) again to squeeze fluid out of the sheet (100). The above steps can be repeated until a desired amount of moisture has been removed from a target area.

In other embodiments, use of the device (10) may not involve any sweeping activity. In such cases, the sheet (100) may be simply placed on a wet surface to absorb moisture from the surface. A user may wait for a certain period while the sheet (100) is resting on the surface to allow the sheet (100) some time to absorb the moisture. The user may then pick up the device (10) (e.g., using the handle (300)), and may go to another location for releasing the moisture in the sheet (100). For example, the user may walk to a corner of a court or outside the court, and perform the wringing activity as described above to release the moisture in the sheet (100).

Several variations of the embodiment may be considered to enhance the functionality or usability of the device (10). Some of them include but are not limited to: (a) finishing the bottom edge of the frame (180) (the edge facing the wet surface) with a blade or blades acting as fluid pushers to combine fluid pushing with wiping in a single sweep, (b) elevating the frame slot (210) in such a way that the space between the wet surface and the slot can be used for installing a gutters (on both sides of the frame (180)) to guide the fluid coming of the squeezed sheet (100) during the wringing phase, (c) using wheels on both ends of the frame (180) to ease the sweeping movement, (d) arranging the frame slot (210) between a pair of freely rotating drums to ease the wringing movement, or (e) providing a cranking mechanism to one of such rotating drums to facilitate wringing movement of the sheet (100) without pulling the sheet end. Each of these features is described below.

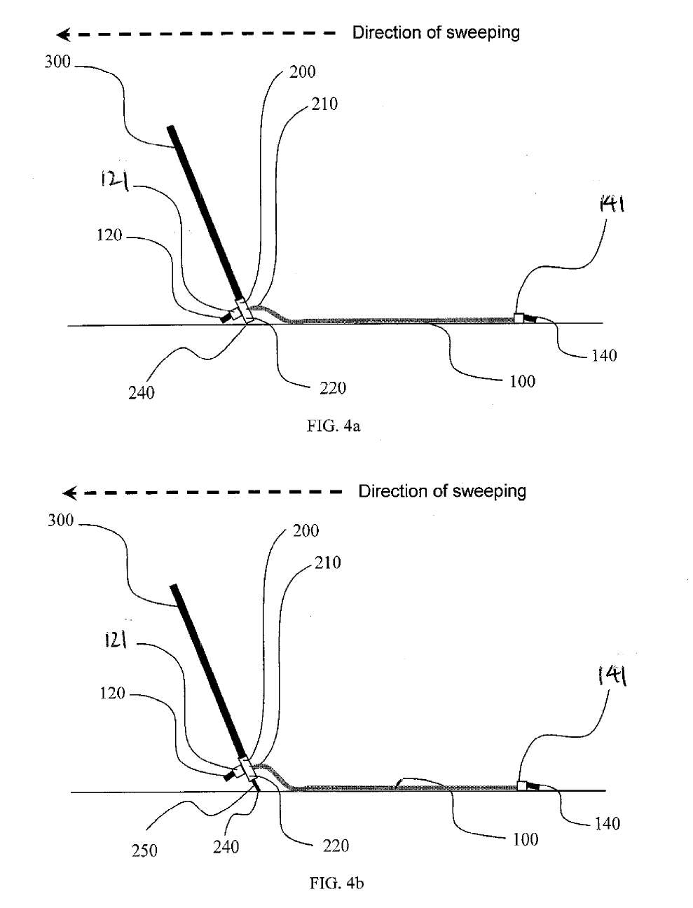

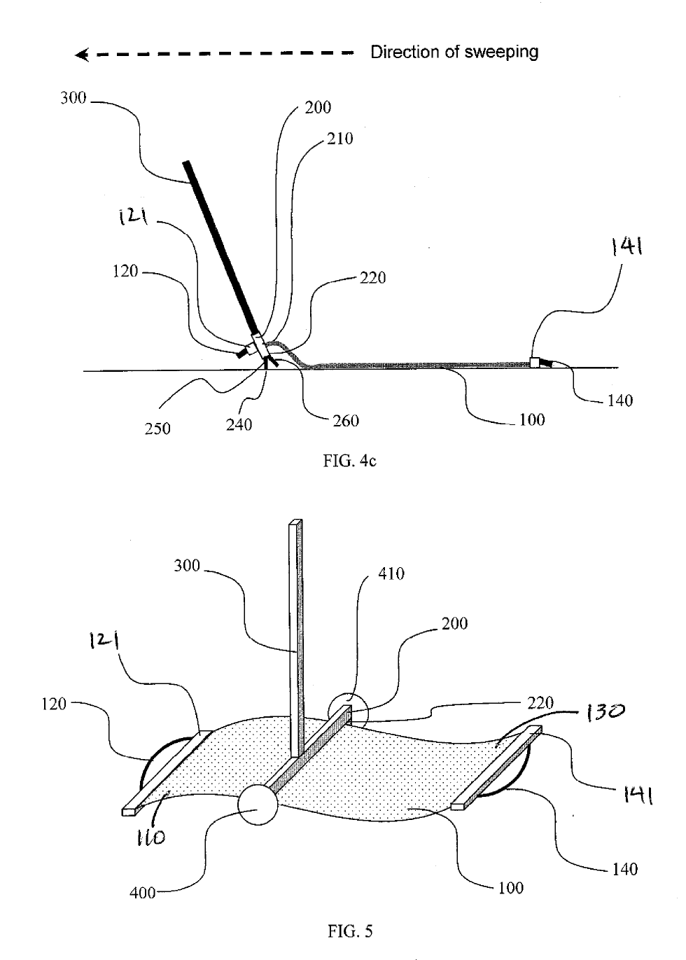

In any of the embodiments described herein, the device (10) may include fluid pushing edge(s) (squeegee(s)). FIG. 4a shows a side view of the device during a wiping sweep. It shows the elements of the device (10) described earlier: a handle (300) attached to the upper bar (200), a sheet of fluid absorbing material (100) with a first end (110), a first handle (120) attached to the first end (110), a second end (130), and a second handle (140) attached to the second end (130), the lower bar (220), and the slot (210) between the lower bar (220) and upper bar (210.) It additionally shows the edge of contact (240) between the lower bar (220) and the surface being wept.

In some cases, when the frame (180) is dragged over the surface, the frame (180) makes contact with the surface along the edge (240) shown in FIG. 4a. This accomplishes to some extent the effect of pushing the fluid residing on the surface in the direction of the frame's movement. This effect can be further intensified by equipping the bottom edge of the frame (180) with a blade made of flexible material like rubber that adapts to the surface shape, and help avoiding gaps between the edge and the surface dues to the flatness imperfections of the surface. FIG. 4b shows a side view of another embodiment of the device that includes a piece of flexible material (250) that is secured to the bottom of the lower bar (220). During use, the flexible material (250) conforms to the surface of the ground, thereby allowing fluid on the ground to be pushed effectively towards the direction of the frame's movement. In other embodiments, the material (250) needs not be so flexible such that it conforms to the surface of the ground. For example, in other embodiments, the blade material (250) may be relatively hard, and may be used to push away objects, e.g., debris, during use.

Considering the fact that the frame (180) is positioned at a certain angle to the surface during a wiping sweep, the effect can be further enhanced by providing an arrangement of two (or more) flexible bottom edges (250) and (260) of the frame (180), each oriented at a specific angle to the frame as shown in FIG. 4c. FIG. 4c shows a scenario in which edge (250) is making contact with the surface because the fluid-absorbing sheet (100) is on the right-hand-side of the lower bar (220). When the device is used to sweep in the opposite direction, the fluid-absorbing material will be on the left-hand-side of the lower bar (200), in which case, the flexible edge (260) would be making contact with the surface being wept.

In any of the embodiments described herein, the device (10) may include wheels. Having the lower edge of the frame (180) make contact with the surface being swept achieves the effect of pushing the fluid in front of the device and possibly increases the effectiveness of fluid removal in a single sweep. In some embodiments, the device can include flexible fluid pushing edge(s), which further increases such effectiveness. However, it does it at the cost of increased force that may be needed to pull the device during a wiping sweep. Another embodiment involves attaching wheels to the side ends (230) of the frame (180) made of bars (200) and (220). This embodiment that includes wheels (400) and (410) is shown schematically in FIG. 5. The exact type and form factor of the wheels as well as the way such wheels are attached to the frame (180) is subject to implementation. The main principle of the illustrated embodiments is to elevate the lower edge of the frame (180) above the surface being wept.

In any of the embodiments described herein, the device (10) may include guide(s) (e.g., gutter(s)) for fluid release during wringing. One of the inconveniences of the wringing phase is that the fluid squeezed from the fluid-absorbing material drips down on the side of the frame (180) from which the fluid-absorbing material is being dragged through the frame slot (210). This fluid may be unwanted in the close proximity of the device. One possible remedy for this phenomenon is to intercept the dripping fluid underneath the frame slot (210) using a form of a gutter attached along the lower bar. The gutter can be closed at one of its ends and finished with a flexible hose at the other end so that the fluid being removed from the fluid-absorbing material during the wringing operation can be directed to a convenient destination, e.g. outside the tennis court fence. FIG. 6 illustrates the feature of this embodiment. In this figure, the fluid-absorbing material mounted is omitted for clarity purpose, but it is understood that the fluid-absorbing material is to be placed in the slot (210). The lower bar (220) is extended vertically to form a blade to which gutter (500) is attached. The gutter runs along the blade at an angle allowing the fluid to go down to the lower end finished with a hose (510). During a wiping sweep, the free end of the hose can be attached to the handle (300), e.g., via a clamp or other holding device. FIG. 6 shows only one side of the blade. The other side of the blade can be equipped with a gutter and a hose as well.

This gutter feature can be combined with any of the embodiments discussed herein, including the embodiments having the flexible edges at the bottom edge of the frame (180), and/or the embodiments having wheels.

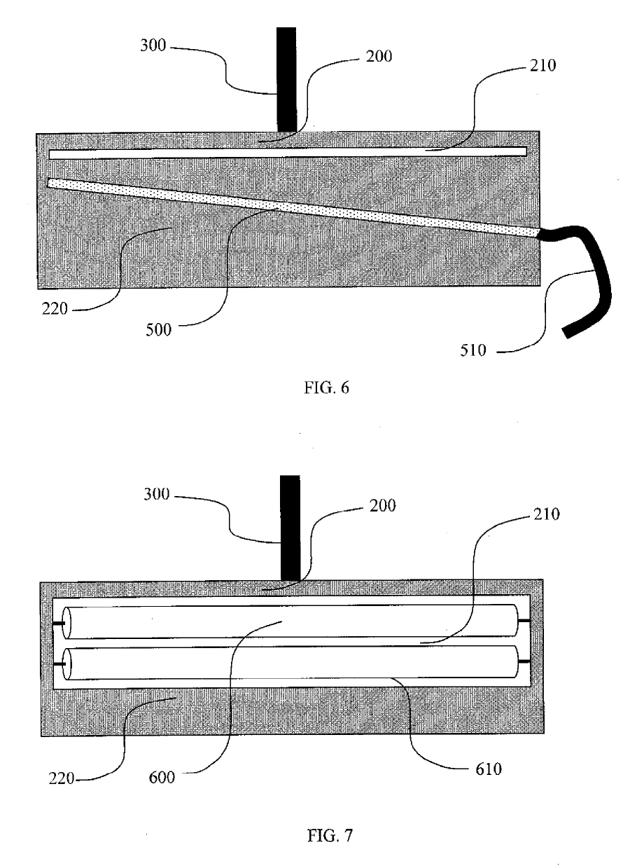

In any of the embodiments described herein, the device (10) may include rotating drums that form a wringing slot. This embodiment includes a wringing slot arranged as a gap between two bars (or rollers). There are multiple possibilities of shaping the wringing slot. For example, the drums (or rollers) may be mounted on axels to let them rotate freely as the fluid-absorbing material is dragged through the gap between them. FIG. 7 shows schematically another embodiment of the device that includes rotating drums. In this embodiment, the upper bar (200) and the lower bar (220) do not directly cause the fluid in the absorbing material to be squeezed out. Instead, the bars (200, 220) provide a frame to which the axles of the upper rotating drum (600) and the lower rotating drum (610) are mounted. The wringing slot (210) is formed by the gap between drum (600) and drum (610). Each of the bars (200, 220) may have different cross sections in different embodiments. For example, the bar (200 or 220) may have an oval cross section. In other examples, the bar (200 or 220) may have other cross sections. The bars (200, 220) may have the same cross sections, or different cross sections. In some cases, providing a cross section for the bar 200 (and/or bar 220) that does not have a sharp edge has the benefit of allowing the fluid-absorbing material to be moved through the slot 210 more easily.

This embodiment can be combined with any of the embodiments discussed herein, including the embodiments having the flexible edges at the bottom edge of the frame (180), and/or the embodiments having wheels. It can be also combined with the embodiments having the fluid guides or gutters.

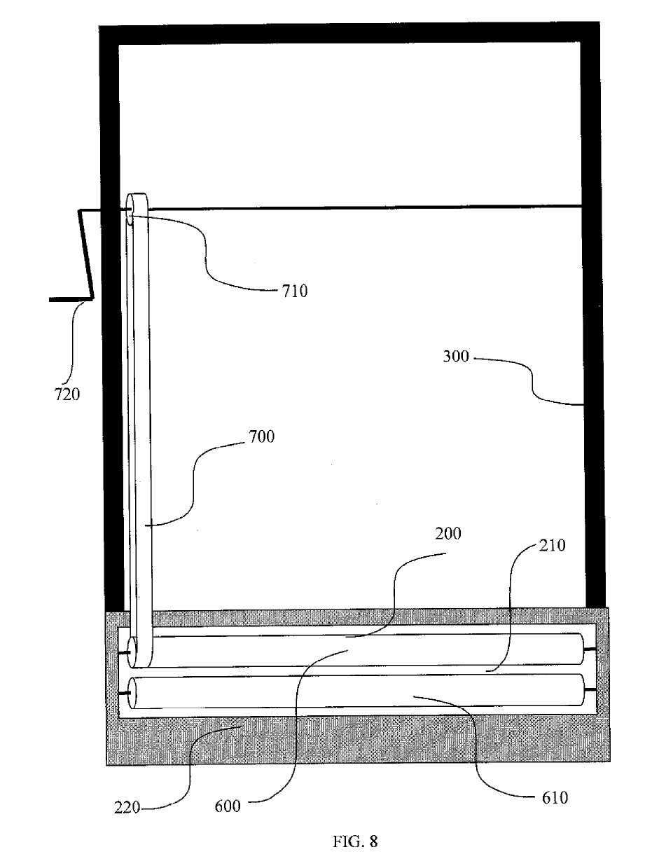

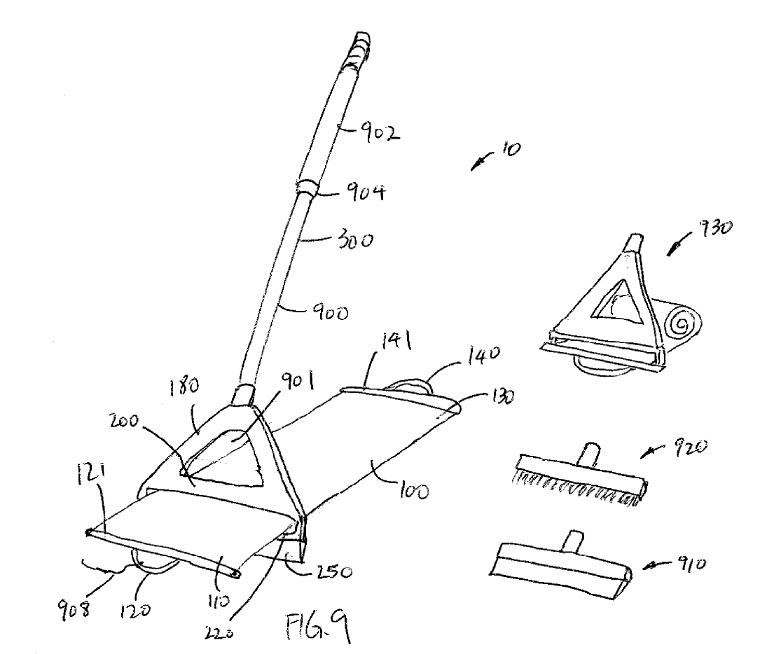

In any of the embodiments described herein, the device (10) may include rotating drums, one of which is propelled by a cranking handle. The effect of dragging the fluid-absorbing material through the wringing slot can be accomplished in many ways. In the above embodiments, the device (10) includes a handle attached to one of the ends of the material, which allows the fluid-absorbing material to be manually pulled through the slot (210). In other embodiments, the device (10) can include two rotating drums, at least one of which is propelled by a cranking handle. This feature allows the fluid-absorbing material to be moved through the slot more easily. FIG. 8 shows a schematic representation of this embodiment. The device pulling handle (300) is arranged here as an open frame (three vertical bars connected by a horizontal bar) in order to support the cranking mechanism (720) that propels the upper rotating drum (600) by coupling it with wheel (710) through a coupling belt (700).

This embodiment can be combined with any of the embodiments discussed herein, including the embodiments having flexible edges at the bottom edge of the frame (180), and/or the embodiments having wheels. It can be also combined with the embodiments having the fluid guides or gutters.

It should be noted that the device (10) should not be limited to the shape illustrated in the above embodiments, and that the device (10) may have other shapes and configurations in other embodiments. FIG. 9 illustrates a variation of the device (10) that has a different shape from those in the above described embodiments. The device (10) includes the frame (180), the handle (300), and the sheet (100) of fluid absorbing material. As shown in the figure, the frame (180) has a triangular/trapezoidal shape, and includes at least one opening 901 for reducing the weight of the frame (180). The frame (180) includes bars (200), (220), which may be integrally formed together with the rest of the frame (180) in some embodiments.

The device (10) also includes a blade (250) at the bottom of the frame (180), which may be used to push objects, such as debris. In some cases, the frame 180 and the blade 250 may be integrally formed together. Alternatively, the blade (250) is not required, and the device (10) does not include the blade (250).

In the illustrated embodiments, the handle (300) is detachably coupled to the frame (180). The handle (300) includes two elongated members (900) (902) that are slidable relative to each other so that the length of the handle (300) may be adjusted. The handle (300) also includes a knob (904) that can be rotated to secure the elongated members (900) (902) relative to each after a desired length of the handle (300) has been accomplished.

The device (10) of FIG. 9 is advantageous in that it can be disassembled, and collapsed into a smaller size for transport purpose. For example, the device (10) may be disassembled by removing the handle (300) from the frame (180), and be collapsed by shortening the handle (300) (FIG. 10). The device (10) may also be collapsed by rolling the sheet (100) and using a securing mechanism (908) to keep the rolled sheet (100) in the rolled-up configuration. In the illustrated embodiments, the securing mechanism (908) is a string that is secured to the handle (120). During use, the sheet (100) is rolled up, and the string is used to wrap around the rolled-up sheet (100). The string loops back towards the handle (120), and may be tied against the handle (120). In other embodiments, other securing mechanisms may be used, such as a snap fastener, a velcro™, etc., for preventing the sheet (100) from unrolling after it is rolled-up. After the device (10) is collapsed, the components of the device (10) (including any accessories) may then be placed inside a small bag (950). In some cases, the bag has a size that allows the bag (950) to be placed inside a racquet bag, such as a tennis-racket bag.

The device (10) of FIG. 9 is also advantageous in that after the frame (180) is decoupled from the handle (300), another device with a different functionality may be detachably coupled to the handle (300). For example, in other embodiments, one or more accessories may be provided with the device (10), each of which may be selectively coupled to the handle (300). The accessories may include a blade (910), a brush (920), another head (930) (that includes another frame with a sheet of fluid absorbing material), etc. The additional head may be a replacement for the original head when the original frame (180) and/or the original sheet (100) is worn out, in which case, the additional head may have the same configuration as the original head. Alternatively, the additional head may have a different configuration as that of the original head. For example, the additional head may have a frame that is longer and may carry a wider sheet of fluid absorbing material. The additional head may also carry another fluid absorbing material that has different fluid absorbing characteristic (e.g., more absorbing) from that of the original sheet (100).

Although particular embodiments have been shown and described, it will be understood that they are not intended to limit the present inventions, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. A device for removing wetness, comprising:
a frame having a slot;
a sheet of fluid absorbing material, at least a portion of which is located in the slot, wherein the sheet has a first end and a second end;
a first handle coupled to the frame; and
a second handle coupled to the first end.

2. The device of claim 1, further comprising a third handle coupled to the second end.

3. The device of claim 1, further comprising a rod secured to the first end, wherein the second handle is attached to the rod.

4. The device of claim 1, wherein the frame includes a first bar and a second bar.

5. The device of claim 4, wherein the first and second bars are secured to each other using a mechanical coupler.

6. The device of claim 5, wherein the mechanical coupler is operable to adjust a size of the slot.

7. The device of claim 4, wherein the first bar and the second bar are integrally formed together.

8. The device of claim 1, further comprising one or more flexible blades at a bottom of the frame.

9. The device of claim 1, further comprising a gutter at the frame.

10. The device of claim 9, further comprising a hose in fluid communication with the gutter.

11. The device of claim 10, further comprising a securing device at the first handle for detachably securing the hose relative to the first handle.

12. The device of claim 1, further comprising two rollers that define the slot.

13. The device of claim 12, wherein one of the rollers has an oval cross section.

14. The device of claim 12, further comprising a cranking mechanism for propelling one of the rollers.

15. The device of claim 1, further comprising two wheels coupled to the frame.

16. The device of claim 1, wherein the first handle is detachably coupled to the frame.

17. The device of claim 16, further comprising an accessory, wherein the accessory is capable of being detachably coupled to the first handle when the frame is detached from the first handle.

18. The device of claim 1, wherein the first handle has a length that is adjustable.

19. The device of claim 1, further comprising a bag for housing the frame, the sheet, the first handle, and the second handle.

20. The device of claim 19, wherein the bag has a size that allows the bag to be placed inside a racket bag.

21. The device of claim 1, further comprising a securing mechanism coupled to the sheet, wherein the securing mechanism is configured to prevent the sheet from unrolling from a rolled-up configuration to a relatively flat configuration.

22. A method for removing wetness on a surface, comprising:
placing a sheet of fluid absorbing material on a wet surface;
pulling a first end of the sheet relative to a slot in a first direction so that part of the sheet moves through the slot to remove moisture from the sheet.

23. The method of claim 22, further comprising pulling a second end of the sheet relative to the slot in a second direction that is opposite from the first direction.

24. The method of claim 22, wherein the surface is a part of a sport court.
